(19) United States
(12) Patent Application Publication
(10) Pub. No.: US 2007/0085301 A1
(43) Pub. Date: Apr. 19, 2007

(54) Center-of-gravity tilt-in-space wheelchair

(76) Inventor: Mervyn M. Watkins, Rancho Palos Verdes, CA (US)

Correspondence Address: GREENBERG TRAURIG LLP, 2450 COLORADO AVENUE, SUITE 400E, SANTA MONICA, CA, 90404, US

(21) Appl. No.: 11/315,443

(22) Filed: Dec. 21, 2005

Related U.S. Application Data
(60) Provisional application No. 60/728,134, filed on Oct. 18, 2005.

(51) Int. Cl. B62B 7/00

(52) U.S. Cl. 280/642

(57) ABSTRACT

A center-of-gravity tilt-in-space wheelchair includes footrests extended to armrest height making the footrests part of the folding base of the wheelchair. This is accomplished by extended members which connect the seat and back to the footrests. The extended members thus rotate about the approximate center of gravity of the wheelchair occupant seated in the wheelchair making tilting and folding of the wheelchair lighter and easier. The upper portion of the wheelchair, which includes the seat and back, can be quickly and easily separated from the lower base which includes the footrests as an integral part.

### RELATED APPLICATION

This application claims the benefit of and priority to U.S. Provisional Application Ser. No. 60/728,134, filed Oct. 18, 2005, the contents of which are incorporated by reference herein in its entirety.

### BACKGROUND OF THE INVENTION

1. Field of the Invention

The invention relates to wheelchairs; and, more particularly, to a center-of-gravity tilt-in-space wheelchair that easily and quickly collapses into a folded position.

2. Related Art

Tilting wheelchairs are well known. Such wheelchairs are typically used in highly dependent or geriatric care, wherein the ability to reposition a wheelchair occupant in various angular positions is beneficial to the occupant's health and daily routine. Tilting a wheelchair occupant relieves pressure to the wheelchair occupant's ischial tuberosities (i.e., the bony prominence of the buttocks). Continuous pressure to the wheelchair occupant's ischial tuberosities, which is applied when the wheelchair occupant remains in a single seated position, can cause the development of decubitus ulcers (i.e., pressure sores). For wheelchair occupants with severe kyphosis (i.e., curvature of the spine), seated tilting may allow the occupant to look forward and interact with their surroundings. Tilting may also be beneficial to assist with proper respiration and digestion.

Some wheelchair occupants require attendant care, wherein an attendant is responsible for positioning the wheelchair seat angle, often changing the angle on a prescribed schedule. The ability to tilt the wheelchair occupant offers the occupant a variety of positions that accommodate their daily schedule, including, for example, an anterior tilt for eating at a table and posterior tilt for resting.

Conventional tilting wheelchairs consist of a seat frame that is pivotally mounted to a base frame so that the seat frame tilts to reposition the wheelchair occupant. The pivot axis is typically mounted between the base frame and seat frame, towards the rear of the seat and away from the occupant's center of gravity. Tilting the occupant involves lifting or lowering his or her center of gravity and therefore requires effort on the part of the attendant. Mechanisms, such as springs or gas cylinders, are often employed to assist in tilting the occupant. Typically, levers are attached to handles on a tilting wheelchair. The levers allow an attendant to release a locking mechanism, change the tilt angle by pushing or pulling on the handles, and engage the locking mechanism, which fixes the tilt angle.

Tilting in conventional tilt wheelchairs may invoke a reaction on the part of the occupant who experiences the sensation of being tipped over. The occupant experiences a sensation of being pitched off balance during tilting. Conventional tilt wheelchair designs involve translation of the wheelchair occupant's center of gravity during tilting. Significant effort on the part of the attendant may be required to tilt the wheelchair occupant when the occupant's mass translates during tilting. Moreover, conventional tilt wheelchairs require large base frames and anti-tip devices because tilting the chair displaces the occupant's center of gravity fore and aft over the wheelbase, potentially placing the wheelchair off balance.

Certain prior art wheelchairs of the tilt-in-space type are known that are vertically collapsible from an upright position that allows the seat and back to tilt as a unitary structure. This is to provide for storage and transportation of the wheelchair while providing a comfortable seating for the user.

Known tilt-in-space wheelchairs have the legs or footrests attached directly to the seat. This keeps the relative position of the footrests to the seat constant. Since the legs or footrests are an extension of the seat structure, it is consequently difficult to stabilize. This also makes it difficult and awkward to fold the wheelchair for storage and transportation.

### SUMMARY

There is a need for a tilt-in-space wheelchair where the seat and back assembly is not integral with the footrests so that the upper set and back assembly can be quickly and easily removed from the lower base assembly while retaining the advantages of a tilt-in-space wheelchair.

It is an object of this invention to provide a tilt-in-space wheelchair which maintains the relative position of the footrests to the wheelchair seat during tilting of the wheelchair.

It is another object of this invention to provide a tilt-in-space wheelchair where the seat and back assembly is not integrated with the footrests making removal of the same lighter and easier.

It is still another object of this invention to provide a tilt-in-space wheelchair which is easier to fold.

These and other objects are carried out by providing a tilt-in-space wheelchair where the footrests are extended to armrest height making the footrests part of the folding base of the wheelchair. This is accomplished by extended members which connect the seat and back to the footrests. The extended members thus rotate about the approximate center of gravity of the wheelchair occupant seated in the wheelchair making tilting and folding of the wheelchair lighter and easier.

### BRIEF DESCRIPTION OF THE DRAWING

The above-mentioned features and objects of the present disclosure will become more apparent with reference to the following description taken in conjunction with the accompanying drawings wherein like reference numerals denote like elements and in which:

FIG. 1 is a front perspective view of the center-of-gravity tilt-in-space wheelchair according to the teachings of the invention, parts thereof being omitted for convenience of illustration;

FIG. 2 is a side perspective view of the wheelchair of FIG. 1;

FIG. 3 is a view similar to FIG. 1 illustrating a tilted position of the wheelchair thereof;

FIG. 4 is a side view of the wheelchair of FIGS. 1 to 3 in a fully reclined position;

FIG. 5 is a side view of the wheelchair of FIG. 4 in a subsequent tilted position;

FIG. 6 is a front perspective view of the wheelchair of FIGS. 1 to 5 illustrating removal of the seat and back assembly from the bottom base assembly;

FIG. 7 is a schematic illustration of the latching and pivoting means of the wheelchair of FIGS. 1 to 6;

FIG. 8 is a schematic illustration of the tilting of the wheelchair of FIGS. 1 to 7 up to 60°;

FIG. 9 is a view similar to FIG. 8 illustrating reclining of the back of the wheelchair of FIGS. 1 to 8;

FIG. 10 is a schematic view illustrating the separation of the seat and back unit from the base unit of the wheelchair of FIGS. 1 to 9;

FIG. 11 is a schematic view of the base unit alone of the wheelchair of FIGS. 1 to 10 after separation of the seat and back unit;

FIGS. 12 and 13 are schematic views of the folded seat and back assembly and folded base assembly alone, FIG. 13 showing the base assembly in an upright vertical position;

FIG. 14 is a schematic view of the folded sections of FIGS. 12 and 13 stored as a unit;

FIG. 15 is a detailed view of a portion of the wheelchair of FIG. 1 illustrating portions of the operating mechanism thereof;

FIG. 16 is a perspective view of a portion of the apparatus of FIG. 15 removed from the sleeve housing;

FIG. 17 is a detailed view of a portion of the wheelchair of FIG. 1 illustrating the foot operating mechanism thereof;

FIG. 18 is a detailed view of the operating mechanism of FIG. 15 showing another orientation thereof and actuation of the unlocking lever;

FIG. 19 is a detailed view of a portion of the wheelchair of FIG. 1 illustrating the quick release mechanism;

FIG. 20 is a view similar to FIG. 13 showing the base assembly in a folded horizontal position;

FIG. 21 is a detailed view of a portion of the operating mechanism of FIG. 15;

FIG. 22 is a view taken along lines 22-22 of FIG. 21;

FIG. 23 is a detailed view of a portion of the operating mechanism of FIGS. 17 to 19; and

FIG. 24 is a detailed view of a portion of the view in FIG. 23.

### DESCRIPTION OF THE PREFERRED EMBODIMENT

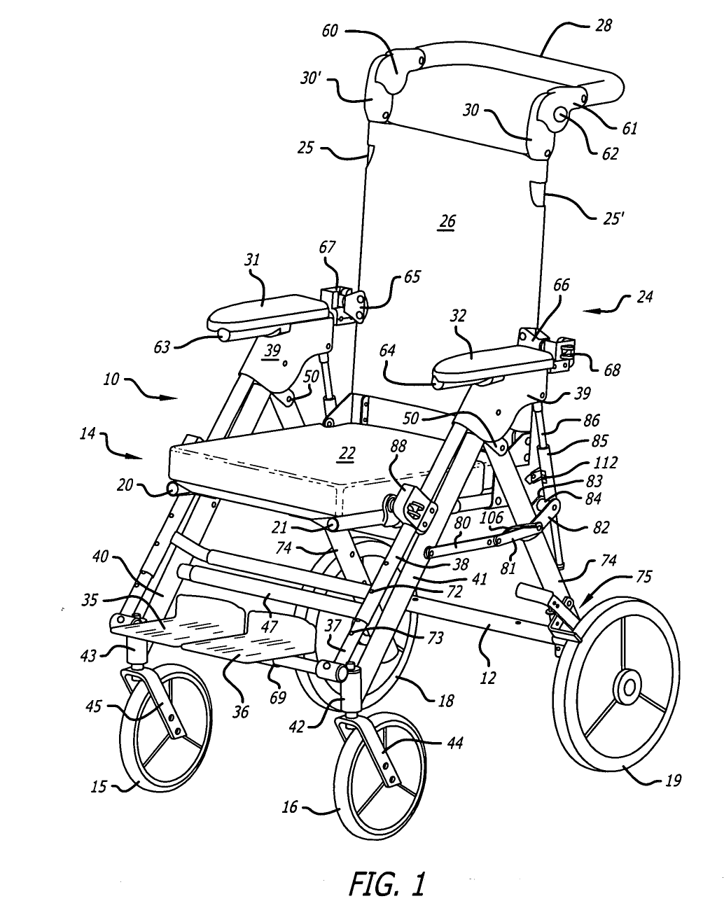

Referring now to FIG. 1 of the drawing, a tilt-in-space center-of-gravity wheelchair 10 in accordance with the teachings of the invention is shown. The wheelchair 10 has a base frame 12 and a seat assembly 14 supported by base frame 12. Base frame 12 is supported on a supporting surface by wheels, such as a pair of spaced front casters 15, 16, and spaced rear wheels 18, 19.

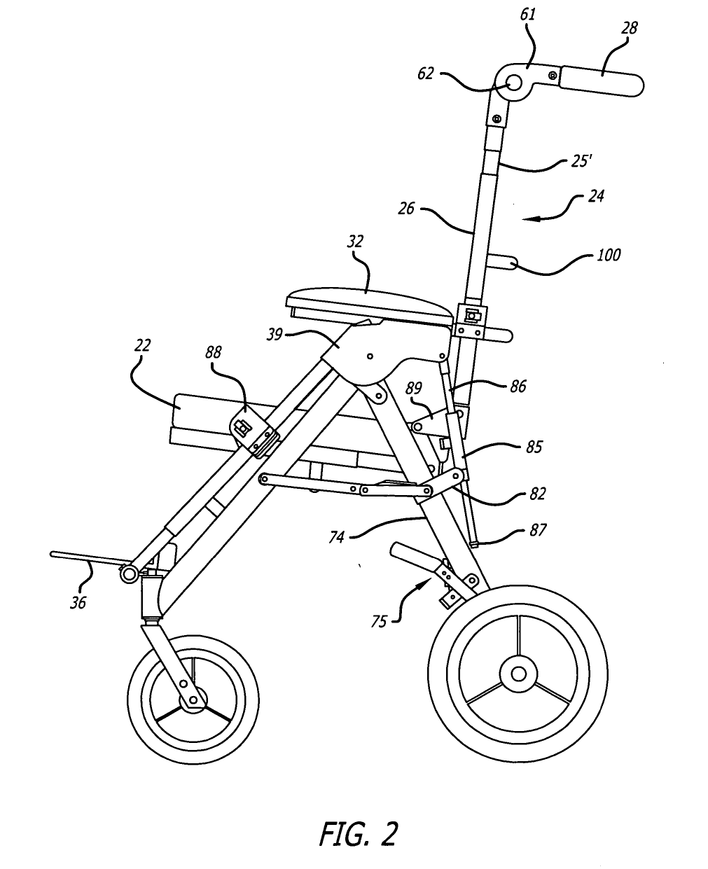

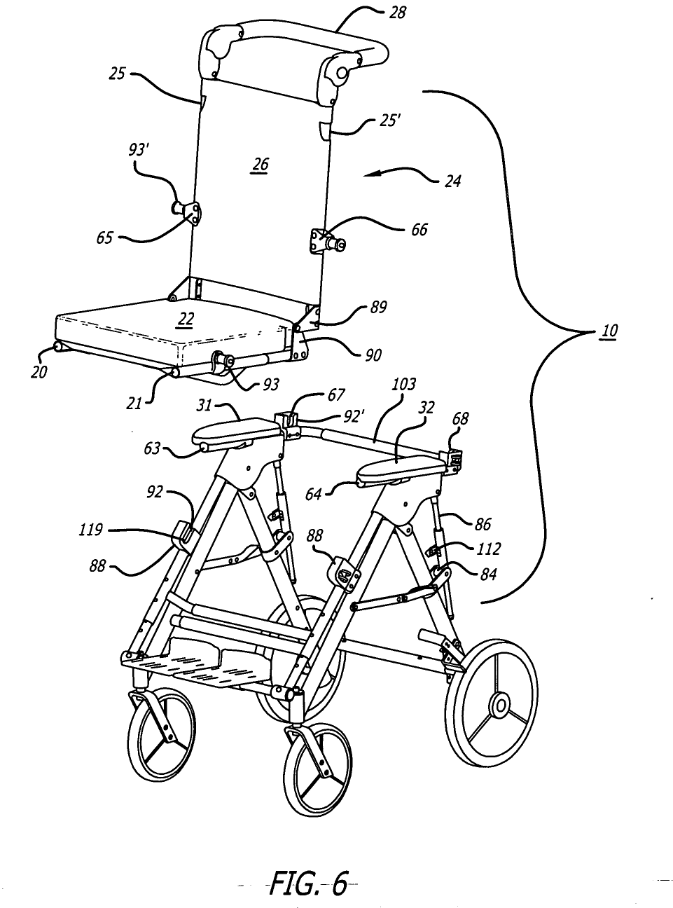

The seat assembly 14 has a seat frame in the form of spaced longitudinally extending tubes 20, 21 (see also FIG. 6) for supporting a seat 22. Any suitable seat may be provided, such as the planar seat shown in FIG. 1. Such seat may be semi-rigid or rigid, padded, contoured, foldable, a contoured profile seat, or a lightweight sling seat as is well known in the wheelchair art. The seat frame also includes a seat back 24 comprises of a pair of spaced rods 25, 25′ supporting therebetween a back support 26 (see also FIG. 2). A U-shaped rod 100 may interconnect rods 25, 25′. Back support 26 may be padded or of stretched canvas and adjusts to the back of the occupant.

Rods 25, 25′ may be telescopingly adjustable as is well known in the wheelchair art, and terminate at top in a generally U-shaped handle 28. Handle 28 is secured to contoured couplings 60, 61 (FIG. 1) pivotally connected via pivot pins 62 (only one visible in FIG. 1) to couplings 30, 30′ that are adapted to releasably hold handle 28 in fixed relation to rods 25, 25′ in a variety of positions as is well known in the art.

A pair of spaced armrests 31, 32 (FIG. 1) are provided mounted to rods 63, 64 extending to brackets 67, 68 (see particularly FIG. 6) which, as will be discussed further, are releasably attached to release latches 65, 66 (FIG. 1) fixed to back support 26, having extending knob elements 93′ (FIG. 6) releasably mounted in U-shaped slots 92′ in latches 65, 66 in a quick release manner as is well known in the wheelchair art. These knob elements 93′, slots 92′ and latches 65 to 68 form cylindrical mechanical locks as will be discussed.

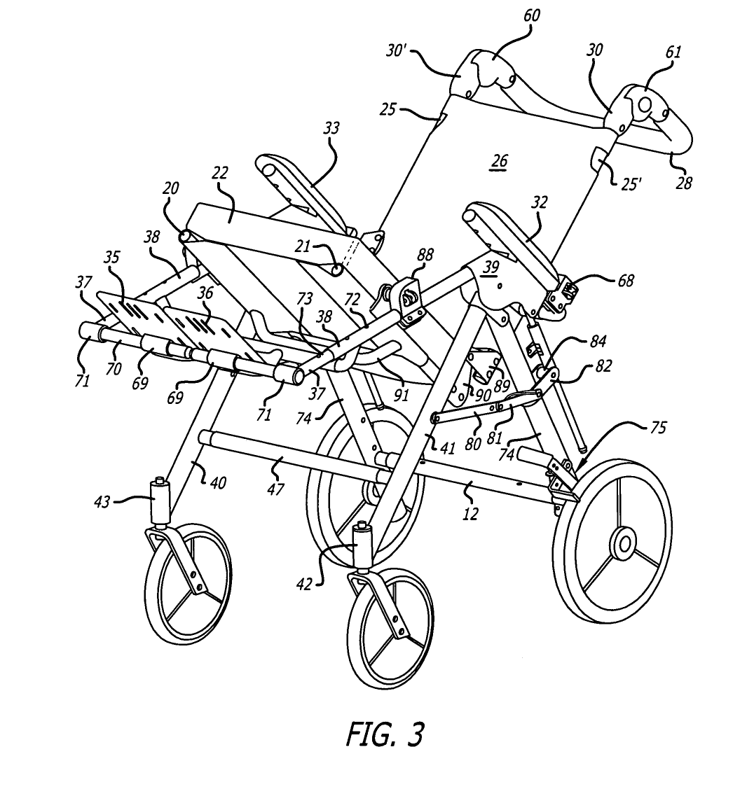

A pair of spaced footrests 35, 36 (FIG. 1) are provided. The underside of each footrest (see FIG. 3) is secured to a sleeve 69 through which rod 70 extends. Rod 70 has caps 71 at each end. As particularly contemplated in the present invention, each footrest is connected to its respective armrest (thus, footrest 36 is connected to rod 37 which is telescopingly mounted in rod 38 and adjustable therein as indicated by holes 72 (in rod 38) and spring biased elements 73 (in rod 37) again as is well known in the art. Rod 38 is in turn connected to approximately the middle bottom of armrest 32. Rods 38 extend through spaced mounting sleeves 39 below armrest 32 as will be discussed. Footrest 35 is connected to armrest 33 in like manner.

Base frame 12 (FIG. 1) includes spaced opposing side tubes 40, 41 extending at one end to sleeves 39 and at the other end to caster housings 42, 43 which support caster yokes 44, 45 on which casters 15, 16 are rotationally mounted, as is well know in the art. Rear wheels 18, 19 can also be mounted in any suitable manner, as by being rotatably mounted to the lower end of spaced tubings 74. A conventional quick release brake lever assembly 75 is also mounted to tubing 74 adapted to engage wheel 19.

A front rod 47 connects tubes 40, 41. The frame of the wheelchair 10 also includes rod 74 connected at top to sleeves 39. Rods 74 are connected via brackets 50, to sleeve 39.

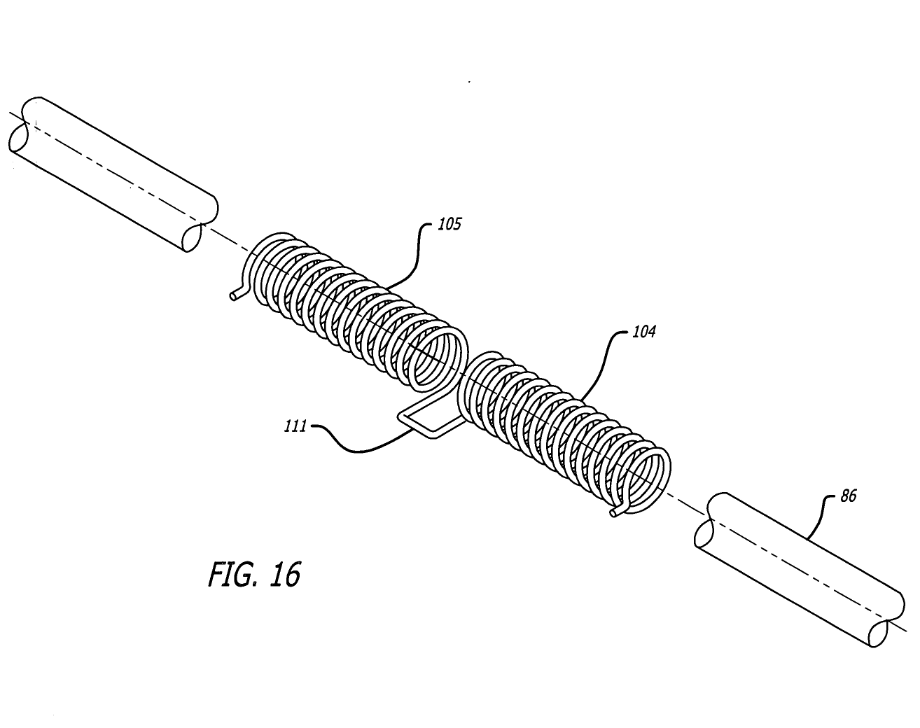

Side tubes 40, 41 are pivotally connected to brackets 80 which are in turn pivotally connected to brackets 81. Brackets 81 are pivotally connected to tubings 74. Tabs 82 (see also FIG. 6) are welded to tubings 74 (FIG. 15) and to the lower end of a conventional mechanical lock 104 (see also FIG. 16) mounted in sleeve 85 as will be discussed. Rod 86 extends through mechanical lock spring 105 in sleeve 85 and a stop 87 (FIG. 2) is provided at the bottom of rod 86.

Rods 38 extend through quick release latches 88 also coupled to tubes 21 and to seat 22. As will be discussed, each latch 88 (FIG. 6) has a U-shaped slot 92 receiving a knob element 93 therein extending from tubes 20, 21 in quick release engagement as is well known in the wheelchair art.

Back support 26 is pivotally connected via spaced brackets 89, to brackets 90 fixedly secured to seat 22. Also, as seen in FIG. 3, tubes 20, 21 are wrapped with the material comprising seat 22 to secure the same thereto. A U-shaped bracket 91 (FIG. 3) is coupled to tubes 20, 21 at the bottom for added support. A like bracket 103 (FIG. 6) is coupled to rods 63, 64 at the point of connection of brackets 67,68.

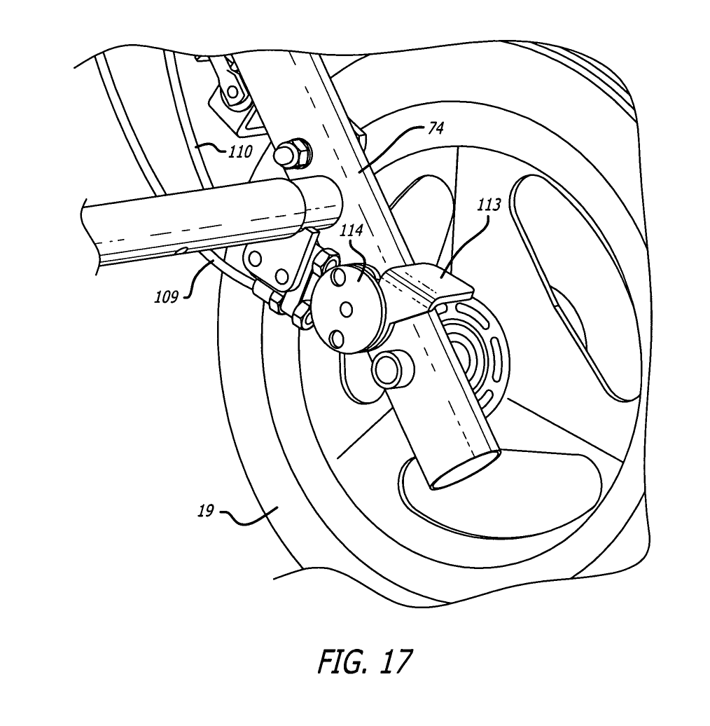

Each release latch 65, 66, 88, such as latch 88 in FIG. 19, is actuated by a lock release lever 116 pivotally mounted on flange 117 of latch 88. When the pins are mounted in their respective slots, such as slot 92 in FIG. 19, spring based locking pin 118 enters hole 119 in slot 92 (see FIG. 6) and is locked therein until lock release lever 116 is pulled to push pin 118 out of hole 119 to thereby disengage roller 93.

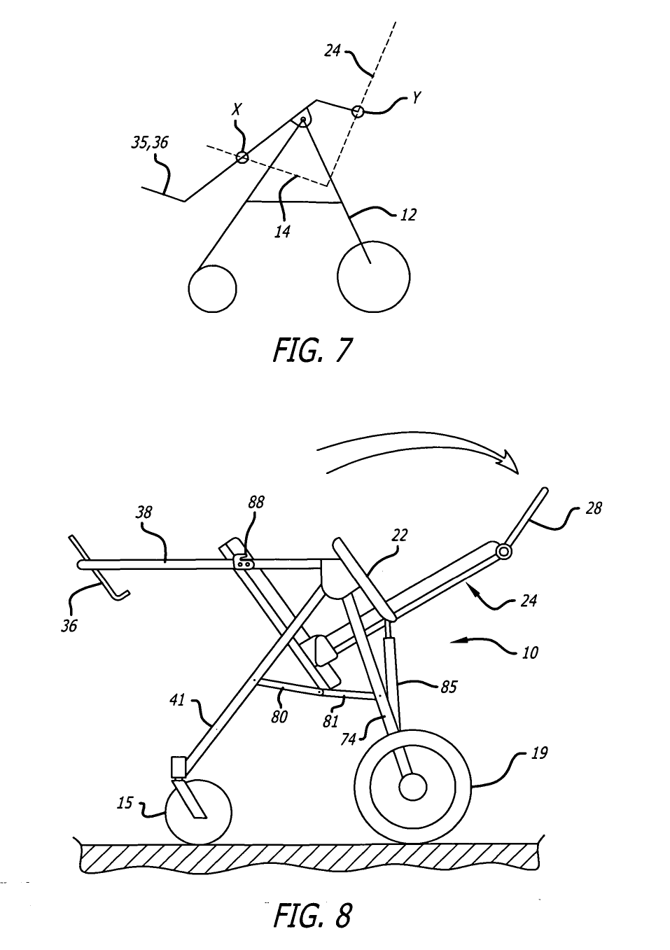

The operation of the wheelchair 10 of the invention is shown schematically in FIG. 7. The docking latches and pivot points are at points X and Y. Latches 88, slots 92 and knob elements 93 are at point X, and latches 65 to 68, slots 92′ and knob elements 93′ are at point Y. This allows disconnect of the back latch and swinging down of the seat assembly 14 (seat assembly 14 and back 24 shown in dotted lines) for easy folding. As seen, the tilting footrest/armrest member is permanently attached to the base frame 12.

FIG. 8 illustrates the upper or top wheelchair unit of wheelchair 10 tilting from a 90° upright position up to 60° therefrom when the foot operated mechanical lock is engaged.

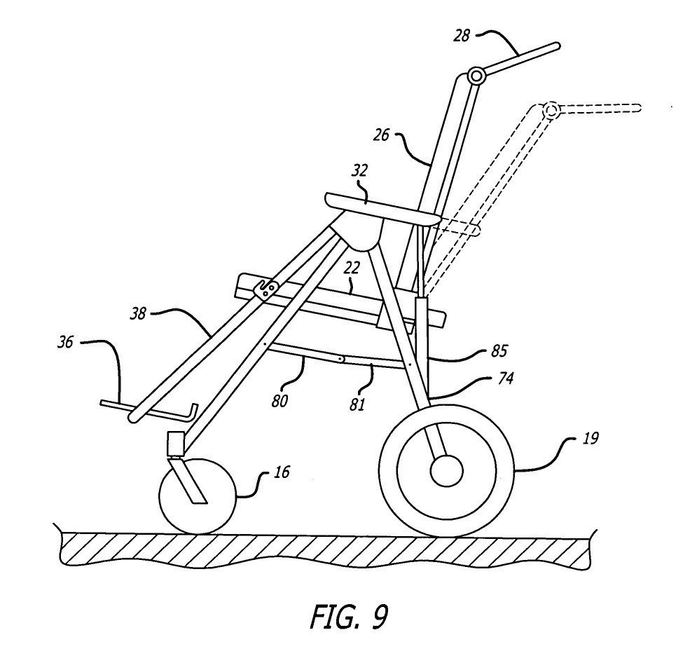

FIG. 9 illustrates how the armrests 31, 32 can be extended by the rods 86 to move the seat back 26 to the reclined position shown in dotted lines.

Although various systems are known for operating the mechanisms of wheelchair 10, as seen in FIG. 1, a side lock mechanism 106 is mounted to bracket 81 (see also FIG. 15) having a cable 107 extending through a sleeve 108 down through tubing 109.

Although any suitable release mechanism may be used, I contemplate a locking cable 110 coupled to a mechanical locking device of the type manufactured and sold by P. L. Porter Controls, Inc. of Burbank, California under the name “Mechlok”, which is a registered trademark. A Mechlok is a mechanical, linear locking device that combines the rod, housing, bushings, locking springs, actuation lever, and attach ends into a fully integrated assembly. It consists primarily of a steel rod gripped by two locking springs that bear against specially configured holding bushings swaged into a surrounding tubular housing.

These single mechanical locks have one maximum stroke setting that can lock at any position of the travel range and have positive locking capabilities in both directions. There are many sizes and strokes to suit all applications up to 2,000 lbs. [8,896 N] axis load.

A compression spring also provides a variable return force to return the lock back to the fully extended position.

Cable 110 is connected at bracket 112 (FIG. 15) to sleeve 85 and extends into the interior thereof where it engages the extended mid-portion 111 (FIG. 16) of spring 105 for actuating the same, by twisting to unlock spring 105 from engagement with shaft 86, as is well known in the art.

The cable release is foot operated. Thus, as seen in FIG. 17, a foot pedal disk 114 is provided actuated by foot operated lever 113. As seen in FIG. 15, side lock mechanism 106 is in the form of a round plate and a pointed projection 121 on lever 115 sits in a matching notch 122 in plate 106. By lifting lever 115 in a clockwise direction, projection 121 is lifted out of engagement with matching notch 122 (FIG. 18) while simultaneously the cable 107 in tubing 109 is pulled which actuates the foot pedal disk 114, as will be discussed.

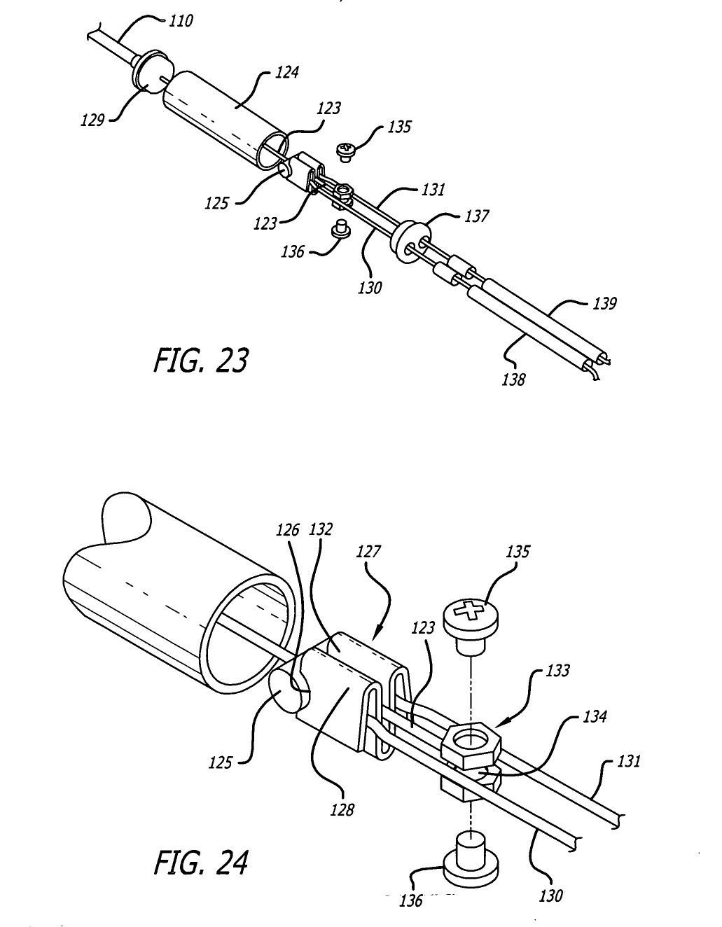

Since it is desired to have a single cable actuate both mechanical locks 104, as seen in FIGS. 23, and 24, cable 123, which extends through tubing 110 from disk 114, extends through an end cap 129 of tubing 124 to a cylindrical coupler 125 mounted in a curved area 126 of a cable spacer 127. Spacer 127 has a first outer curved portion 128 through which a first cable 130, secured to coupler 125, extends. A second cable 131 extends from coupler 125 through a second outer curved portion 132 of spacer 127. Cables 130, 131 extend to the center spring 111 of each mechanical lock 104 as seen in FIG. 22 (only cable 130 shown in FIG. 22).

Cable 123 (FIG. 23) extends through the area between curved portions 128, 132 of spacer 127 to a nut assembly 133. Nut assembly 133 has a throughbore 134, through which cable 123 extends, and is secured therein by threaded screws 135, 136. Both cables 130, 131 extend through a second end cap 137 (FIG. 23) and respective tubings 138, 139 to each respective mechanical lock as seen in FIG. 22. It is to be understood that the parts shown in FIGS. 23 and 24 are assembled inside of tubing 124, end caps 129, 137 closing off the open ends. When cable 123 is pulled, the left and right hand mechanical locks 104 are operated simultaneously.

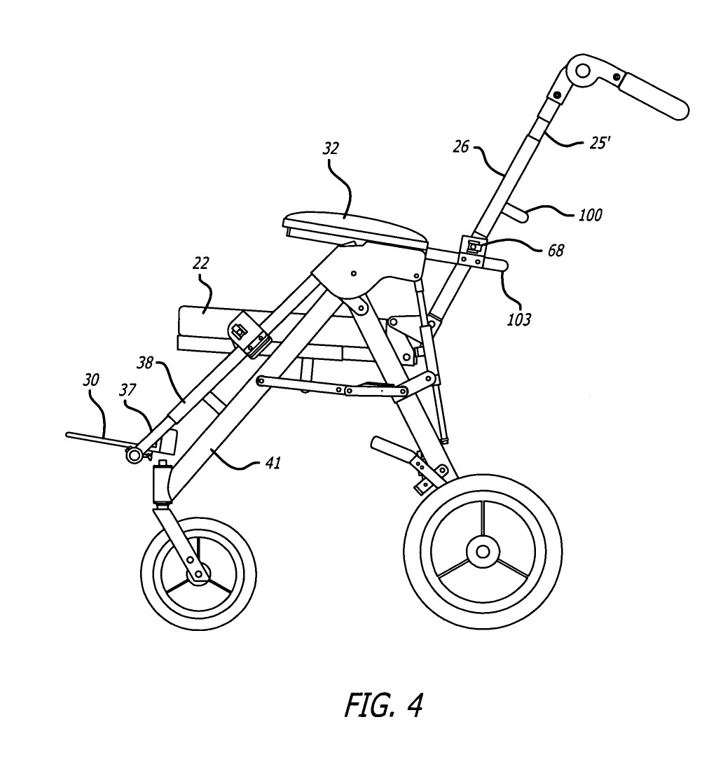

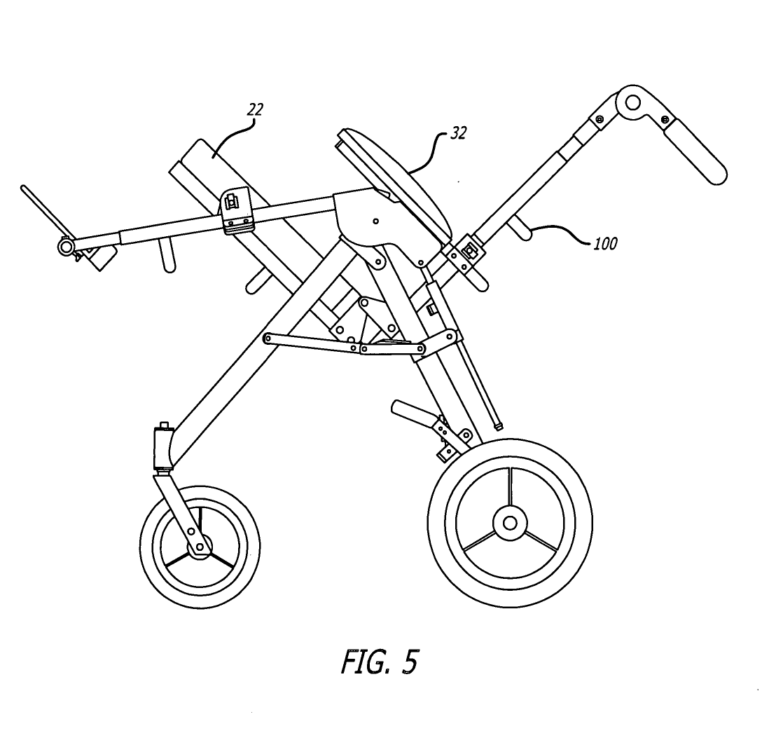

In operation, the wheelchair 10 is in the FIG. 2 position. Footrests 35, 36 are pulled away from rods 40, 41 as seen in FIG. 4. Rods 37 telescope within rods 39 and the back 26 moves backwardly as the seat 22 moves upwardly (see FIG. 3), then to the FIG. 5 position.

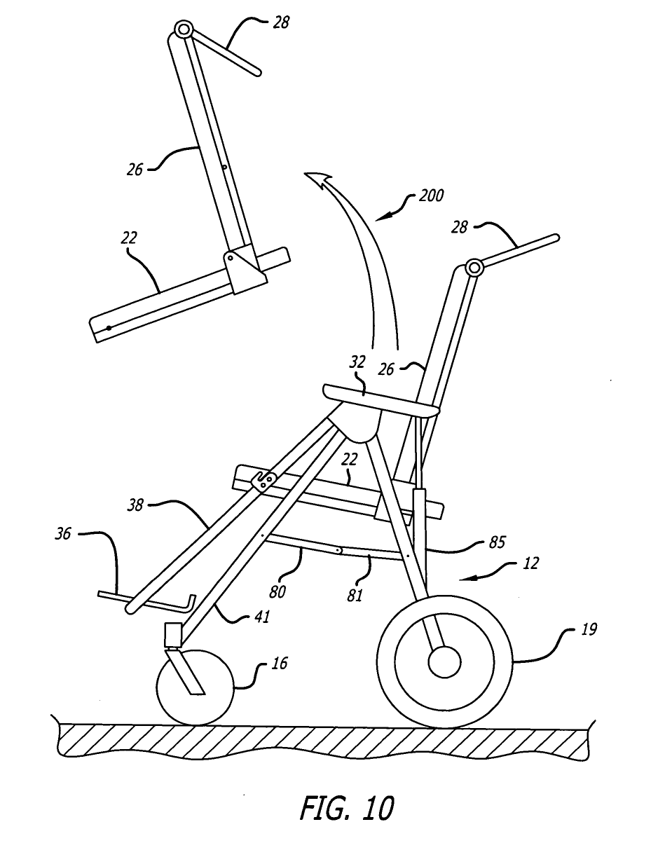

When it is desired to disassemble wheelchair 10, as for storage and the like, as seen in FIG. 6, brackets 65, 66 and knob elements 93′ are released from brackets 67, 68 by release of knob elements 93′ from slots 92. Similarly, knob elements 93 are removed from brackets 88 in like manner. The seat 22 and back 26 assembly shown at top in FIG. 6 can be quickly and easily removed from the bottom assembly in the direction of the arrow 200 ass shown schematically in FIG. 10.

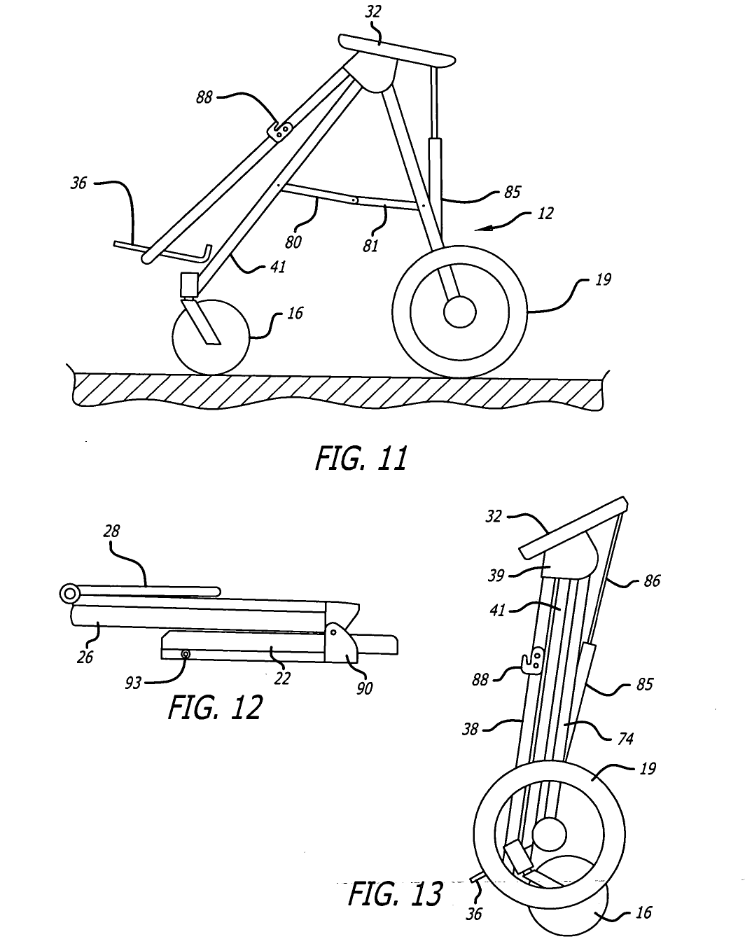

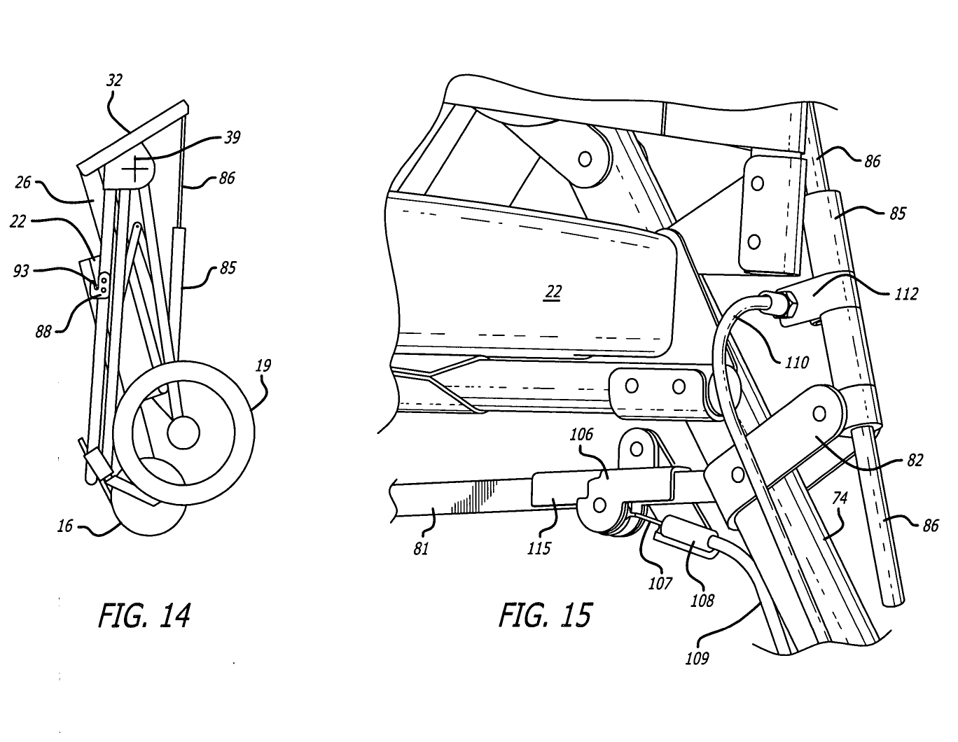

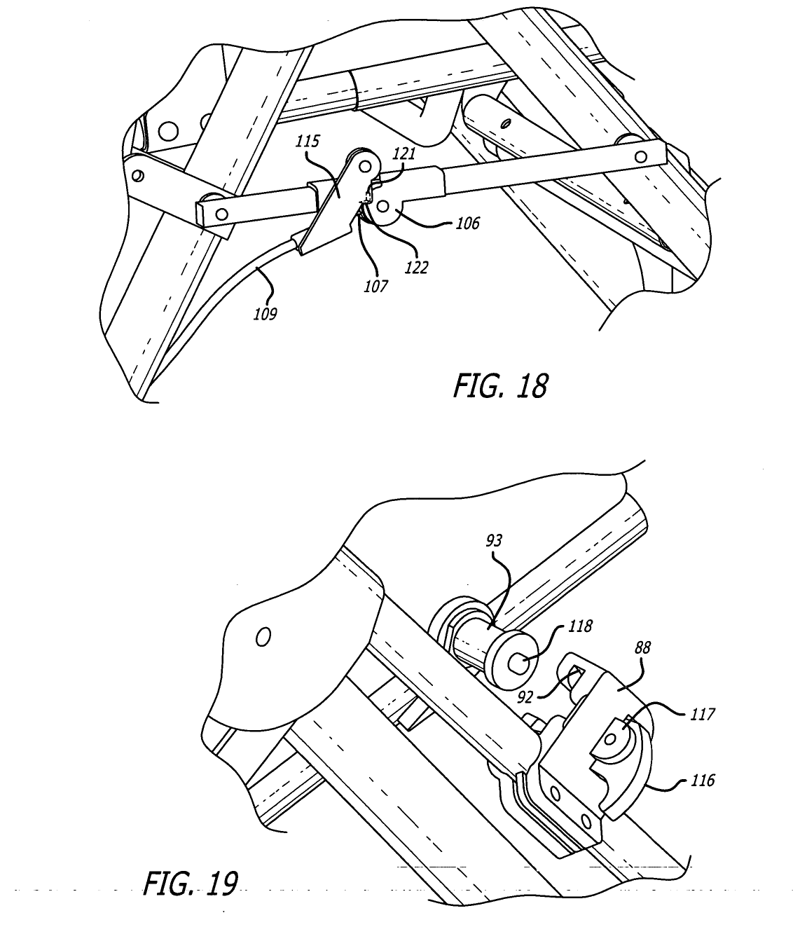

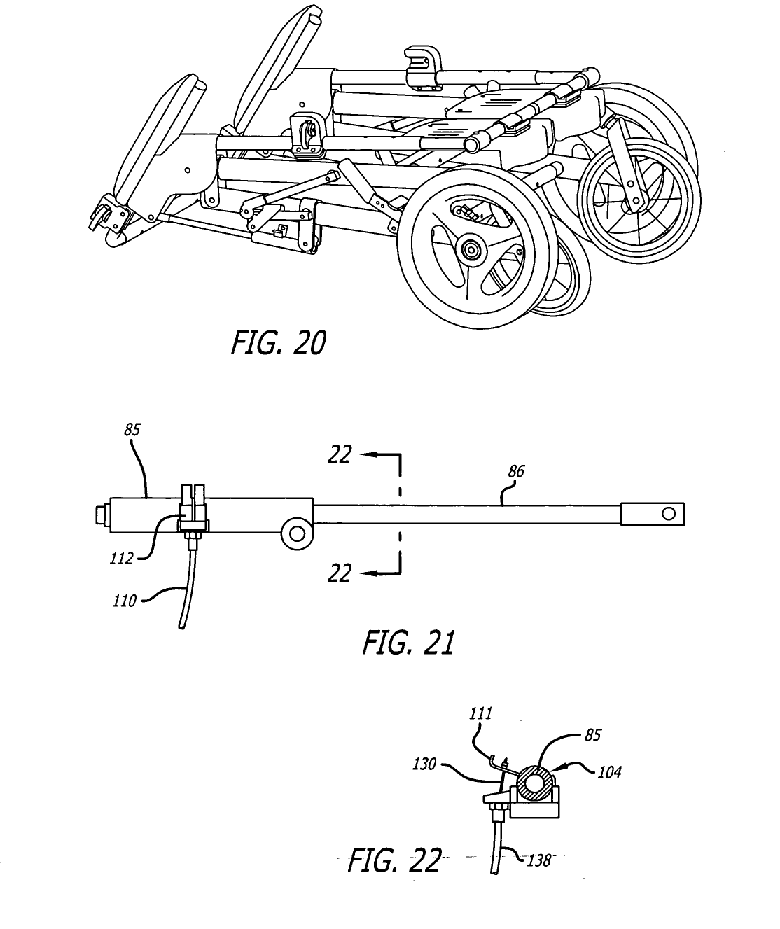

The bottom assembly alone, after removal of the seat and back assembly, is shown in FIG. 11. FIGS. 12 and 13 illustrate folding of each of the assemblies shown in FIG. 11. As seen in FIG. 12, the seat 22, back 26 and handle 28, are folded into one unit. As seen in FIG. 13, the armrests 31, 32 and the tubes and rods of base frame 12 are folded into one unit. See also FIG. 20 wherein the folded base assembly is in a horizontal position. As seen in FIG. 14, the folded seat and back assembly can be stored within the folded bottom assembly, by engaging the knob elements 93 on the seat tubes 20, 21 within slots 92 of the latches 88 of the bottom assembly.

It can be seen that there is disclosed a tilt-in-space wheelchair which consists of a sturdy member extending from the footplates to the armrests, and pivoting on the chair base close to the center of gravity of the seat and occupant. This member, which is an integral part of the base, supports the removable seat assembly so that the seat, footrests, and armrests tilt as a unit. The angle of the pivoting member is such that, as the occupant gets larger, the footrests adjust appropriately down and forward to match the seat depth forward extension and the occupant's longer leg length.

This allows for a tilt-in-space feature, with firm leg/footrests, and maintains the relative position of the footrests to the seat during tilting. The legrests are no longer extensions of the seat, making removal of the seat/back from the base lighter and easier. The integration of the legrests with the base makes the chair much easier to fold.

Different seating systems may be used. The wheelchair may be folded into a compact assembly with the seat attached. It tilts and reclines as desired, has an adjustable width, wheelbase and footrests. The footrests stay with the base frame and are non-elevating.

Although a particular variation of the invention is disclosed, variations thereof may occur to an artisan and the scope of the invention should only be limited by the scope of the appended claims.

I claim:

1. In a tilt-in-space wheelchair including a base, a seat for supporting an occupant, a pair of spaced back supports connected to the seat having a back connected thereto for supporting the back of an occupant, wheels associated with the base for supporting the base on a supporting surface for rolling movement therealong, a pair of arm rests mounted on the base on opposite sides of said seat, a pair of footrests mounted on said base forwardly of said seat and below the plane of said seat, the improvement which comprises:
said seat, said back and said back supports being interconnected forming a top wheelchair unit, said base, said wheels, said armrests and said footrests being interconnected and forming a bottom wheelchair unit.

2. The wheelchair of claim 1 wherein said top wheelchair unit is releasably secured to, and removable from, said bottom wheelchair unit.

3. The wheelchair of claim 2 including said spaced back supports having upper ends and a handle movable between locking positions mounted to the upper ends of said spaced back supports and removable from said bottom wheelchair unit along with said top wheelchair unit.

4. The wheelchair of claim 1 wherein said seat is mounted between a pair of spaced tubes, each of said tubes having a first releasable locking member thereon, each of said armrests being mounted to an upper rod telescopingly mounted in a lower rod, each of said rods fixedly mounted to a mounting member having said footrests fixed thereto.

5. The wheelchair of claim 4 wherein each of said upper rods has a second releasable locking member engagable with said first releasable locking member.

6. The wheelchair of claim 5 including lever actuated release means coupled to said second releasable locking member for release of said first releasable locking member from said second releasable locking member.

7. The wheelchair of claim 5 including a pair of third releasable locking members mounted on each of said back supports, and fourth releasable locking members mounted rearwardly of each of said armrests engagable with said third releasable locking members.

8. The wheelchair of claim 7 including lever actuated release means coupled to said fourth releasable locking members for release of said third releasable locking members from said fourth releasable locking members.

9. The wheelchair of claim 1 wherein said wheels include a pair of spaced front wheels coupled to a like spaced pair of side tubes, each of said side tubes being coupled to each of said armrests.

10. The wheelchair of claim 9 wherein said wheels include a pair of spaced rear wheels, each of said rear wheels being connected to a like pair of tubings coupled to each respective armrest.

11. The wheelchair of claim 10 including a first bracket fixed to each of said side tubes pivotally connected to a second bracket fixed to each of said tubings.

12. The wheelchair of claim 1 wherein said top wheelchair unit folds to a position wherein said armrests are at top and said wheels are at bottom and said top wheelchair unit folds to a position where said back rests on said seat.

13. The wheelchair of claim 12 wherein said folded top wheelchair unit is releasably locked to said folded bottom wheelchair unit.

14. The wheelchair of claim 1 wherein said top wheelchair unit tilts rearwardly with respect to said bottom wheelchair unit.

15. The wheelchair of claim 14 wherein said top wheelchair unit is tiltable with respect to said bottom wheelchair unit from a 90° upright position up to 60° therefrom.

16. The wheelchair of claim 1 including a mechanical lock associated with said wheelchair base for moving said armrests rearwardly thus tilting said top wheelchair unit with respect to said bottom wheelchair unit.

17. The wheelchair of claim 16 wherein said mechanical lock is foot actuated.

18. The wheelchair of claim 16 wherein said mechanical lock is a spring biased release mechanism raising said top wheelchair unit into an upright position and releasable to tilt the same rearwardly with respect to said bottom wheelchair unit.

19. The wheelchair of claim 18 wherein said release mechanism is foot operated.

20. The wheelchair of claim 18 wherein a pair of said mechanical locks are provided, each operated by a single foot operated release cable.

21. A tilt-in-space wheelchair comprising:
a seat;
a footrest removably attached to said seat; and
tilting means associated with the footrest for tilting the same and moving said footrest and said seat while maintaining the relative position of the footrest to said seat during tilting thereof.

22. The wheelchair of claim 21 wherein said footrest includes a pair of interconnected footrest members.

23. The wheelchair of claim 21 wherein said footrest extends to and is connected to a pair of armrests disposed on opposite sides of said seat when said seat is attached to said footrest.

24. The wheelchair of claim 23 wherein said armrests are connected to said footrest by a pair of spaced extended members.

25. The wheelchair of claim 24 wherein each of said extended members includes mating telescoping sections.

26. The wheelchair of claim 24 wherein said extended members rotate about the approximate center of gravity of an occupant on said chair thereby making tilting and folding of the wheelchair lighter and easier.

27. The wheelchair of claim 21 wherein a back is fixedly mounted to said seat.
